(19) United States
(12) Patent Application Publication
(10) Pub. No.: US 2026/0133332 A1
(43) Pub. Date: May 14, 2026

(54) GENERATING SEISMIC SURFACES

(71) Applicant: Schlumberger Technology Corporation, Sugar Land, TX (US)

(72) Inventors: Bart Goledowski, Tananger (NO); Nestor Herman Cuevas, Tananger (NO); Dirk Gunnar Steckhan, Tananger (NO); Lejun Chen, Tananger (NO); Alexander Ovsyankin, Tananger (NO)

(21) Appl. No.: 18/941,820

(22) Filed: Nov. 8, 2024

(51) Int. Cl. G01V 1/30

(52) U.S. Cl. CPC G01V 1/301; G01V 2210/643

(57) ABSTRACT

A seismic surface generation system may crop a seismic volume within a cropping range of a wellbore trajectory to generate a cropped seismic volume. A seismic surface generation system may resample the cropped seismic volume to a predetermined sampling frequency to generate a resampled seismic volume. A seismic surface generation system may mask the resampled seismic volume within a masking range of the wellbore trajectory resulting in a masked seismic volume. A seismic surface generation system may extract patches from the masked seismic volume based on a signal-to-noise ratio of the masked seismic volume. A seismic surface generation system may generate a seismic surface using the patches.

### BACKGROUND OF THE DISCLOSURE

Many natural resources are accessible located underground. Such natural resources include water reservoirs and hydrocarbon reservoirs such as natural gas and oil. To access these natural resources, downhole drilling systems may drill a wellbore along a trajectory to a target location, formation, or geological feature. To assist in the planning of the trajectory of the wellbore, a drilling system may prepare simulations and projections of geological features. The simulations and projections of geological features may be based on seismic data collected during exploration and drilling operations.

### SUMMARY

In some aspects, the techniques described herein relate to a method for seismic surface generation. A seismic surface generation system crops a seismic volume within a cropping range of a wellbore trajectory to generate a cropped seismic volume. The seismic surface generation system resamples the cropped seismic volume to a predetermined sampling frequency to generate a resampled seismic volume. The seismic surface generation system masks the resampled seismic volume within a masking range of the wellbore trajectory resulting in a masked seismic volume. The seismic surface generation system extracts patches from the masked seismic volume based on a signal-to-noise ratio of the masked seismic volume. The seismic surface generation system generates a seismic surface using the patches.

In some aspects, the techniques described herein relate to a method for seismic surface generation. A seismic surface generation system preprocesses a seismic volume to reduce processing, resulting in a preprocessed seismic volume. The preprocessing includes cropping the seismic volume, masking the seismic volume, and resampling the seismic volume. The seismic surface generation system identifies a patch of high signal-to-noise ratio in the preprocessed seismic volume. The seismic surface generation system applies a neural network to the patch to generate a seismic surface.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system for drilling an earth formation to form a wellbore, according to at least one embodiment of the present disclosure.

FIG. 2 is a representation of a seismic surface generation system 216, according to at least one embodiment of the present disclosure.

FIG. 3-1 through FIG. 3-3 are representations of a seismic volume, according to at least one embodiment of the present disclosure.

FIG. 4-1 through FIG. 4-4 are representations of a seismic volume, according to at least one embodiment of the present disclosure.

FIG. 5 is a flowchart of a method for generating a seismic surface, according to at least one embodiment of the present disclosure.

FIG. 6 is a flowchart of a method for generating a seismic surface, according to at least one embodiment of the present disclosure.

FIG. 7 is a representation of a computing system, according to at least one embodiment of the present disclosure.

### DETAILED DESCRIPTION

This disclosure generally relates to devices, systems, and methods for seismic interpretation. Seismic data is often used to generate seismic surfaces of underground formations. To generate seismic data, acoustic waves are sent to the subsurface, such as through the use of specially crafted seismic explosive charges, hammers, vibrators, air guns, water jets, onshore seismic sources, such as onshore or air guns, marine vibrators explosive charges, or other offshore seismic sources. The acoustic waves travel through rock formations and may be collected at various locations remote from the seismic source. The seismometers may measure and track the waveform that propagates through the formation. Certain geologic features may generate specific patterns in the waveform. For example, certain geologic features may cause reflections in the seismic waves, thereby altering the waveform. Using the collected seismic waveforms, an operator may identify contrasts between adjacent formations and generate a seismic surface, or a three-dimensional representation of the formation boundaries based on the seismic data.

Conventionally, generating the seismic surfaces is a specialized process, and involves a specialized scientist, engineer, or technician to interpret the seismic data to generate realistic seismic surfaces that are representative of the formation boundaries. Further, this process is highly personalized to the operator, and often two different specialists may generate two different seismic surfaces for the same data. This may result uncertainty in the location of a particular formation, thereby causing inefficiencies in drilling planning and/or operations.

In accordance with at least one embodiment of the present disclosure, a seismic surface generator may automatically generate seismic surfaces using seismic data. The seismic surface generator may first preprocess the seismic data. Preprocessing the seismic data may reduce the processing load. For example, the seismic surface generator may crop the seismic data to a seismic volume having boundaries defined by the wellbore trajectory. Cropping the seismic data may reduce the total amount of data analyzed to generate the seismic surface, thereby reducing the processing load. The seismic surface generator may further mask the seismic data based on a distance from the wellbore trajectory. For example, the seismic surface generator may mask the seismic data based on an offset from the wellbore trajectory. In some embodiments, the seismic surface generator may resample the seismic data to a predetermined sampling. For example, the seismic surface generator may interpolate the seismic data to the predetermined sampling. The predetermined sampling may be based on the sampling rate for one or more seismic interpretation algorithms. Resampling the seismic data may cause the generated seismic surface to be scaled to a known scale, thereby improving the accuracy and/or representativeness of the seismic surface.

After the seismic data is preprocessed, the seismic surface generator may generate the seismic surface. To generate the seismic surface, the seismic surface generator may perform a patch extraction on the seismic data. The patch extraction may include masking seismic data that has a low signal-to-noise (SNR) ratio, or an SNR ratio that is below a threshold. The resulting patch(es) may then be used to generate a surface. In some embodiments, the resulting patches may be used to train a machine learning (ML) model or neural network to generate seismic surface within the masked seismic volume. Utilizing the neural network trained on the signal-consistent patches and snapping of the surface to the correct extrema of the seismic signal may result in a signal-consistent surface. The resulting seismic surface may be further processed to remove surface artifacts, or points or point clusters that diverge from the surrounding depth positions and geometry, such as spikes or holes. This may result in a signal-consistent and geologically-consistent seismic surface.

As illustrated by the foregoing discussion, the present disclosure utilizes a variety of terms to describe features and advantages of the seismic surface generation system. Additional detail is now provided regarding the meaning of such terms. For example, as used herein, the term “seismic volume” refers to a collection of datapoints collected from a seismic sensor. In particular, a seismic volume may include datapoints having a physical location (e.g., x, y, and z coordinates, location and depth coordinates) interpreted from a seismic waveform (such as through an inversion function).

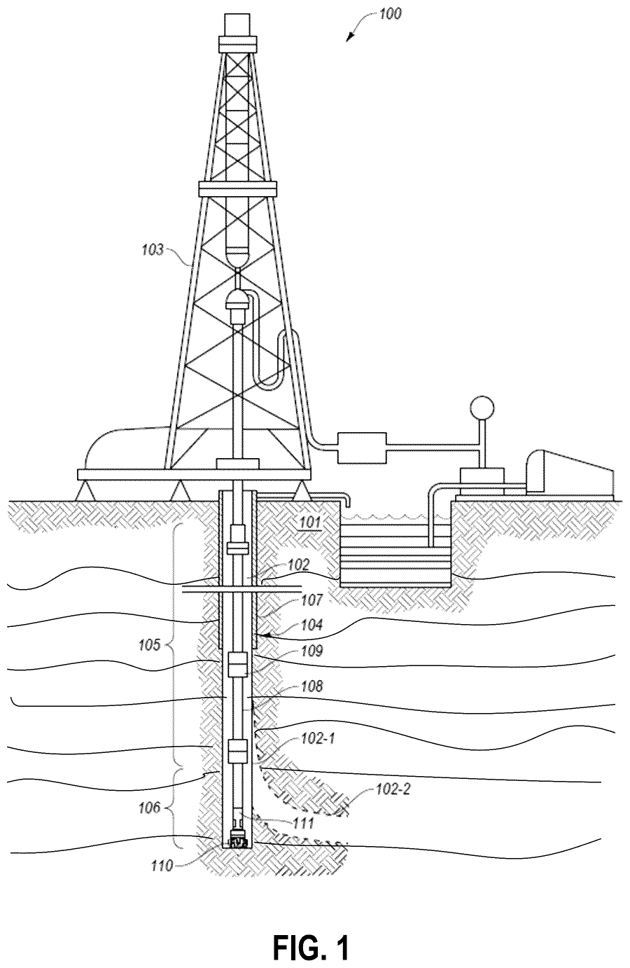

By way of background, FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (BHA) 106, and a bit 110, attached to the downhole end of drill string 105.

The earth formation 101 may include strata 112, or layers of rock. The strata 112 may include an unconformity 113 between individual layers of the earth formation 101. The unconformity 113 may result in a change in rock properties. Such changes in rock properties may result in a change in the propagation of seismic waves through the earth formation 101. For example, an unconformity 113 may be a reflector, and may reflect the seismic waves. The resulting reflected seismic waves may be used to identify the unconformity 113 separating two strata 112.

The drilling system 100 may include a seismic sensor 114. The seismic sensor 114 may detect seismic waves generated by a seismic source 115. The seismic source 115 may include any device capable of generating seismic waves, such as an explosive charge, a hammer, a vibrator, an air gun, a water jet, any other seismic source, and combinations thereof. The seismic source 115 and/or the seismic sensor 114 may be located at any location, including at the surface and/or at a depth underground. In some embodiments, the seismic source 115 may be located in the wellbore 102. When actuated, the seismic source 115 may cause vibrations to travel through the earth formation 101. At least a portion of the vibrations may be reflected at an unconformity 113 between two strata 112. The seismic sensor 114 may measure the reflected waveform to generate seismic data. The seismic data may be converted to physical datapoints in any manner, including through calculations such as an inversion function.

In accordance with at least one embodiment of the present disclosure, a seismic surface generation system may generate a seismic surface of the strata 112 using the seismic data collected by the seismic sensor 114. The seismic surface may be a three-dimensional representation of the strata 112, including the unconformities 113 separating the strata 112. To generate the seismic surface, the seismic surface generation system may preprocess the seismic data to reduce the volume of data to be reprocessed and/or increase the accuracy of the generated seismic surfaces. The preprocessing may include one or more of cropping, masking, and resampling the seismic data.

After preprocessing the seismic data, the seismic surface generation system may generate the seismic surface. To generate a signal-consistent surface, the seismic surface generation system may extract patches of the seismic data having a high SNR. A high SNR region of the seismic volume would be typically characterized by laterally extensive continuous reflectors representing a consistent strata boundary and low proportion of data noise. In contrast, a low SNR region of the seismic volume would be typically characterized by chaotic discontinuous reflections which are not laterally extensive and where the proportion of data noise is high. These patches may be used by a neural network to generate the remaining portion of the seismic surface. The resulting surface may then be processed to remove surface artifacts that are inconsistent with the geometry and/or geology of the strata 112 and/or unconformities 113. This may generate a seismic surface that is consistent with the seismic data collected by the seismic sensor 114 and consistent with known geometric and geological principles related to the earth formation 101.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through nozzles, jets, or other orifices in the bit 110 for the purposes of cooling the bit 110 and cutting structures thereon, for lifting cuttings out of the wellbore 102 as it is being drilled, for controlling influx of fluids in the well, for maintaining the wellbore integrity, and for other purposes.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (MWD) tools, logging-while-drilling (LWD) tools, downhole motors, underreamers, section mills, hydraulic disconnects, jars, vibration or damping tools, other components, or combinations of the foregoing. The BHA 106 may further include a directional tool 111 such as a bent housing motor or a rotary steerable system (RSS). The directional tool 111 may include directional drilling tools that change a direction of the bit 110, and thereby the trajectory of the wellbore. In some cases, at least a portion of the directional tool 111 may maintain a geostationary position relative to an absolute reference frame, such as gravity, magnetic north, or true north. Using measurements obtained with the geostationary position, the directional tool 111 may locate the bit 110, change the course of the bit 110, and direct the directional drilling tool 111 on a projected trajectory. For instance, although the BHA 106 is shown as drilling a vertical portion 102-1 of the wellbore 102, the BHA 106 (including the directional tool 111) may instead drill directional or deviated well portions, such as directional portion 102-2.

The directional portion 102-2 may be directed to a particular stratum 112 or group of strata 112. During well planning, the seismic surfaces generated by the seismic data may be used to generate a wellbore trajectory, or planned path for the wellbore. The trajectory of the directional portion 102-2 may be designed to stay within a certain proximity of a particular unconformity 113. The techniques of the present disclosure may be used to increase the accuracy of the seismic surface and maintain the directional portion 102-2 within the desired portion of the earth formation 101.

Examples of directional tools 111 and/or steering systems may include “push-the-bit” systems, “point-the-bit” systems, hybrid systems, any other system, and combinations thereof. In a push-the-bit system, actuator pads may extend from the directional tool 111 to contact the wellbore wall. The actuator pads may apply a force against the wellbore wall, which may push the bit away from the actuator pad. Other examples of push-the-bit systems may include RSS systems, non-rotating (with respect to the hole) eccentric stabilizers (e.g., displacement-based systems). Steering is achieved by creating non co-linearity between the drill bit and at least two other touch points.

In point-the-bit systems, the axis of rotation of the bit 110 is deviated from the local axis of the BHA 106 in the general direction of the desired path (target attitude). The borehole is propagated in accordance with the customary three-point geometry defined for example by upper and lower stabilizers and the hole reaming cutters. The angle of deviation of the drill bit axis coupled with a finite distance between the lower and middle touch points results in the non-collinear condition for a curve to be generated. This may be accomplished, for example, by a fixed bend at a point in the BHA 106 close to the lower stabilizer or flexure in the drill bit drive shaft distributed between the upper and lower stabilizers.

In general, the drilling system 100 may include additional or other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

In some embodiments, the BHA 106 may include a downhole motor to power for downhole systems and/or provide rotational energy for downhole components (e.g., rotate the bit 110, drive the directional tool 111, etc.). The downhole motor may be any type of downhole motor, including a positive displacement pump (such as a progressive cavity motor) or a turbine. In some embodiments, a downhole motor may be powered by the drilling fluid flowing through the drill pipe 108. In other words, the drilling fluid pumped downhole from the surface may provide the energy to rotate a rotor in the downhole motor. The downhole motor may operate with an optimal pressure differential or pressure differential range. The optimal pressure differential may be the pressure differential at which the downhole motor may not stall, burn out, overspin, or otherwise be damaged. In some cases, the downhole motor may rotate the bit 110 such that the drill string 105 may not be rotated at the surface, or may rotate at a different rate (e.g., slower) than the rotation of the bit 110.

The bit 110 in the BHA 106 may be any type of bit suitable for degrading downhole materials such as earth formation 101. Example types of drill bits used for drilling earth formations are fixed-cutter or drag bits, roller cone bits, and combinations thereof. In other embodiments, the bit 110 may be a mill used for removing metal, composite, elastomer, other downhole materials, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface or may be allowed to fall downhole. In still other embodiments, the bit 110 may include a reamer. For instance, an underreamer may be used in connection with a drill bit and the drill bit may bore into the formation while the underreamer enlarges the size of the bore.

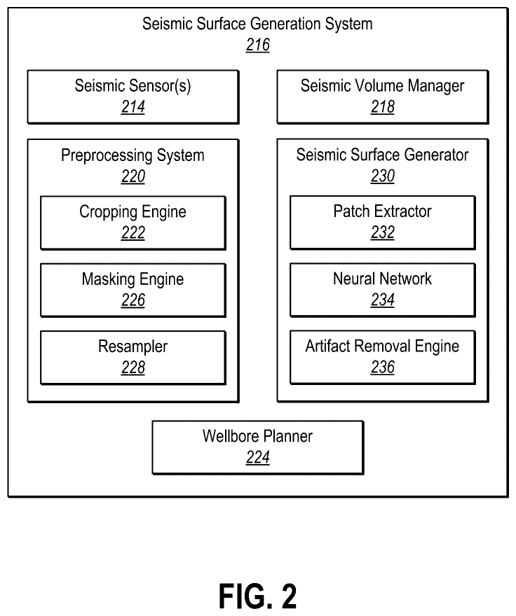

FIG. 2 is a representation of a seismic surface generation system 216, according to at least one embodiment of the present disclosure. Each of the components of the seismic surface generation system 216 can include software, hardware, or both. For example, the components can include one or more instructions stored on a computer-readable storage medium and executable by processors of one or more computing devices, such as a client device or server device. When executed by the one or more processors, the computer-executable instructions of the seismic surface generation system 216 can cause the computing device(s) to perform the methods described herein. Alternatively, the components can include hardware, such as a special-purpose processing device to perform a certain function or group of functions. Alternatively, the components of the seismic surface generation system 216 can include a combination of computer-executable instructions and hardware.

Furthermore, the components of the seismic surface generation system 216 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

As discussed herein, the seismic surface generation system 216 may receive seismic data from one or more seismic sensors 214. The seismic sensors 214 may receive seismic data from vibrations caused by an artificial source (e.g., the seismic source 115 of FIG. 1) and/or vibrations caused by natural sources (e.g., earthquakes). A seismic volume manager 218 may receive the seismic data from the seismic sensors. The seismic volume manager 218 may maintain the various versions and edits to the seismic data as the seismic surface generation system 216 processes the seismic data.

The seismic volume manager 218 may generate the seismic volume into inline sections and crossline sections. The inline sections and crossline sections may form a grid. The seismic datapoints in the seismic volume may have a resolution that is identified by the spacing of the inline sections and crossline sections. The inline sections and crossline sections may be orthogonal to each other. In some embodiments, the inline sections and crossline sections have the same spacing. In some embodiments, the inline sections and crossline sections have different spacing. The inline sections and crossline sections may have any orientation. For example, the inline sections and crossline sections may be oriented north-south and east-west. In some examples, the inline sections and crossline sections may have orientations that have an angle different than north-south and east-west.

Prior to generating a seismic surface, a preprocessing system 220 may prepare the seismic data. The preprocessing system 220 may preprocess the seismic data in any manner. For example, the preprocessing system 220 may include a cropping engine 222. The cropping engine 222 may receive a wellbore trajectory from a wellbore planner 224. The wellbore planner 224 may maintain an up-to-date version of the wellbore trajectory, including the location and depth information for the wellbore. The cropping engine 222 may crop the seismic volume based on the wellbore trajectory to generate a cropped seismic volume. Cropping the seismic volume may include deleting or removing datapoints from the seismic volume. The resulting cropped seismic volume may be smaller than the original seismic volume.

The cropping engine 222 may generate the cropped seismic volume based on the boundaries of the wellbore trajectory, such as a landing location, landing depth, terminal location, and terminal depth. In some embodiments, the landing depth may be the hole depth at which the wellbore trajectory reaches an area of interest. In some embodiments, the landing depth may be the depth below surface at which the wellbore trajectory reaches the area of interest. In some embodiments, the terminal depth may be the hole depth at which the wellbore trajectory ends or terminates. In some embodiments, the landing depth may be the depth below surface at which the wellbore trajectory ends or terminates.

The wellbore trajectory may extend along an x-axis (e.g., east to west), a y-axis (e.g., north to south), and a z-axis (e.g., elevation with respect to sea level, depth below surface). The cropping engine 222 may crop the seismic volume to only include datapoints that are included within the outer extents of the wellbore trajectory, including the north-most extent, the south-most extent, the east-most extent, the west-most extent, the deepest extent, and the shallowest extent. For example, the cropping engine 222 may crop the seismic volume to only include those inline sections and crossline sections that intersect the wellbore trajectory or that come within a cropping threshold of the wellbore trajectory. Additionally, an offset distance value can be added to any of the outer extents of the wellbore trajectory, thus enlarging the cropped volume in x-axis, y-axis and/or z-axis. The resulting cropped seismic volume may be smaller than the seismic volume. This may reduce the overall processing load on the seismic surface generation system 216 during other preprocessing acts and seismic surface generation acts.

The preprocessing system 220 may include a masking engine 226. The masking engine 226 may mask portions of the cropped seismic volume to generate a masked seismic volume. For example, the masking engine 226 may mask portions of the cropped seismic volume that are outside of a masking range of the wellbore trajectory. The masking range may be a distance from the wellbore trajectory within which the seismic surface is relevant to the operator. The masking engine 226 may mask the seismic data outside of any given distance value counted along the given axis (x-axis, y-axis and/or z-axis). The seismic surfaces may be generated only within that masked volume range.

Masking the seismic volume may reduce the processing load. For example, masking the seismic volume may reduce the amount of datapoints that the seismic surface generation system 216 processes when generating the seismic surface. In some embodiments, masking the seismic volume may improve the accuracy, relevance, and/or representativeness of the generated seismic surface. For example, masking the seismic volume based on the masking range may mask irregularities in the seismic data and/or geologic record. This may focus the seismic data on the area immediately surrounding the wellbore trajectory, thereby reducing the chance for erroneous or irrelevant data to impact the generation of the seismic surface.

A resampler 228 may resample the seismic data in the seismic volume. Seismic data may be generated having varied spacing between the datapoints. Further, seismic surface generators may be inflexible, and analyze seismic data based on a predetermined sampling frequency and/or spacing. The seismic data within the seismic volume may be generated with a different spacing or sampling frequency than the predetermined sampling frequency of the seismic surface generator. In particular, the inline and crossline spacing may be different. When the seismic surface generator analyzes the seismic surface data having differing inline and crossline spacing using the predetermined sampling frequency, the accuracy of the resulting seismic surface may be compromised.

The predetermined sampling frequency and/or spacing may be any sampling frequency and/or spacing. For example, the predetermined sampling frequency may include a dimensionless grid used by surface generation systems. In some examples the sampling frequency may include a dimensioned grid, having x, y, and/or z dimensions of 1 m, 2 m, 3 m, 5 m, 10 m, 15 m, 20 m, 25 m, or any value therebetween. In some embodiments, the predetermined sampling may have equal spacing in the x, y, and z dimensions. In some embodiments, the predetermined sampling frequency may have differing spacing in the x, y, and z directions.

In accordance with at least one embodiment of the present disclosure, the resampler 228 may resample the seismic data to the predetermined sampling. For example, the resampler 228 may interpolate the seismic data to generate a resampled seismic volume having resampled seismic data. The resampled seismic volume may then be input to the seismic surface generator to generate the seismic surface having a known scaling. The resulting seismic surface may be representative of the shape and dimensions of the actual formation.

In accordance with at least one embodiment of the present disclosure, the resampler 228 may generate the resampled seismic volume at any time while the preprocessing system 220 is preprocessing the seismic data. For example, the resampler 228 may generate the resampled seismic volume after the cropping engine generates the cropped seismic volume. Put another way, the resampler 228 may resample the cropped seismic volume to generate the resampled seismic volume. The masking engine masking engine 226 may then mask the resampled seismic volume to generate the masked seismic volume. In some examples, the resampler 228 may generate the resampled seismic volume after the masking engine 226 generates the masked seismic volume. Put another way the resampler 228 may resample the masked seismic volume after the masking engine 226 masks the cropped seismic volume.

The seismic surface generation system 216 further includes a seismic surface generator 230. The seismic surface generator 230 may generate the seismic surface from the preprocessed seismic volume. For example, the seismic surface generator 230 may generate the seismic surface from the cropped seismic volume, the masked seismic volume, the resampled seismic volume, and combinations thereof.

To generate the seismic surface, the seismic surface generator 230 may include a patch extractor 232. The patch extractor 232 may analyze the signal-to-noise ratio (SNR) of the seismic volume. For example, the patch extractor 232 may identify points or clusters of points that have an SNR that is greater than a threshold SNR. Extracting patches of high SNR may allow the seismic surface generator 230 to generate the seismic surface that is reliably representative of the actual formation.

In some embodiments, the patch extractor 232 may mask the portions of the seismic volume that are below the threshold SNR. For example, the patch extractor 232 may replace values of the seismic volume with a zero, 1, or other null value. Masking the portions of the seismic volume that are below the threshold SNR may improve the quality and/or reliability of the seismic volume by reducing the consideration of noisy seismic data.

To identify portions of the seismic volume with a high SNR, the patch extractor 232 may calculate a volume attribute to give a proxy for spatial SNR. In some embodiments, the patch extractor 232 may utilize a Frobenius norm based on eigenvalues. However, it should be understood that any other mechanism may be used to identify the SNR for the volumes. For example, patches may be extracted using a Frobenius norm volume technique.

The patch extractor 232 may utilize any mechanism to extract the surface patch from the seismic volume. For example, the patch extractor 232 may utilize a boundary attribute defined using the extrema classification methodology. This may extract signal-consistent patches of seismic horizons while obeying the geological principle of superposition. Other methods may utilize auto-tracking of seismic signal from randomly chosen seed points located within the seismic volume. The SNR threshold for the SNR mask and the minimum size of a single patch may be set high so that only large patches associated with high quality seismic signal are extracted. For example, such large patch can constitute of 50% or of the lateral sample number of the seismic volume. However, it should be understood that any other mechanism may be used to extract the signal-consistent patches.

The seismic surface generator 230 may include a neural network 234 or other machine learning model to complete the seismic surfaces initiated by the patch extraction. The neural network 234 may be trained to interpret surface geometry based on seismic data, interpolate signal-consistent surfaces between high SNR patches extracted by the patch extractor 232, and extrapolate signal-consistent surfaces based on the high SNR patches extracted by the patch extractor 232. For example, the neural network 234 may be trained on extracted patches to generate seismic surfaces. In some embodiments, the neural network 234 may be trained using a portion of the patches extracted by the patch extractor 232. This may increase the accuracy and/or representativeness of the generated surfaces.

The neural network 234 may be trained on an extraction of connected point clouds. A connected point cloud may be a point cloud having clusters of data points separated by spaces with lower data point density. This may facilitate more consistent surfaces that incorporate geological features. For example, this may allow a surface mapped by the neural network 234 that is dissected by a fault can be extracted as a continuous feature.

In some embodiments, the surfaces generated by the neural network 234 may be further refined using a signal-consistent surface interpolation by an artifact removal engine 236. For example, the seismic surface generated by the neural network 234 may include geologically unrealistic edges and spike-like surface artifacts due to extrema snapping in areas where the seismic reflectors diverge. The artifact removal engine 236 may identify these surface artifacts. When the artifacts diverge from the surrounding depth positions and geometry, the artifact removal engine 236 may remove the surface artifacts. The resulting holes are interpolated to generate a signal-consistent surface without surface artifacts.

After removing the surface artifacts from the seismic surface, the seismic surface generator 230 may provide the resulting seismic surface to the operator. The operator may then analyze the seismic surface and make one or more changes to the drilling system. For example, the operator may make a change to the drilling plan to maintain the wellbore trajectory within a target formation. In some examples, the operator may make a change to the operating parameters of the drilling system, including changes to the RSS, to return the bit to the target formation or stratum and/or to prevent the bit from entering or leaving a particular formation or stratum.

The seismic surface generation system 216 may be automatic. For example, when an operator desires to generate a seismic surface for a particular formation or within a particular proximity to a wellbore trajectory, the operator may input or select the desired trajectory from the wellbore planner 224. When the user requests the seismic surface, the seismic surface generation system 216 may automatically identify the relevant seismic volume (e.g., the seismic data received from the seismic sensors 214) from the seismic volume manager 218. The preprocessing system 220 may, as discussed herein, automatically, and without input from the user, process the seismic data in the seismic volume, and the seismic surface generator 230 may generate the seismic surface. In this manner, the operator may generate seismic surfaces without having any specialized knowledge, experience, or training. This may increase the accessibility and/or utility of seismic surfaces.

FIG. 3-1 through FIG. 3-3 are schematic representations of the preprocessing of seismic data in a seismic volume 338, according to at least one embodiment of the present disclosure. The seismic volume 338 includes a wellbore trajectory 340 extending therethrough. The seismic volume 338 is bounded by an x-axis 342, a y-axis 344, and a z-axis 346. The seismic volume 338 may be formed from a plurality of cubes formed from inline sections (e.g., along the x-axis 342), crossline sections (e.g., along the y-axis 344), and elevation sections (e.g., along the z-axis 346). For visual clarity, the cubes have not been illustrated in the seismic volume 338.

As may be seen, the wellbore trajectory 340 extends through the seismic volume 338, and may cross over multiple inline sections, crossline sections, and elevation sections. When the operator requests the generation of a seismic surface, a cropping engine may crop the seismic volume 338 to only include the cubes that intersect the wellbore trajectory 340, cubes in contact with cubes that intersect the wellbore trajectory 340, cubes that are within a cropping range of the wellbore trajectory 340, and combinations thereof. In some embodiments, the cropping range may have an upper value, e.g. 1 m, 10 m, 100 m or any other distance value.

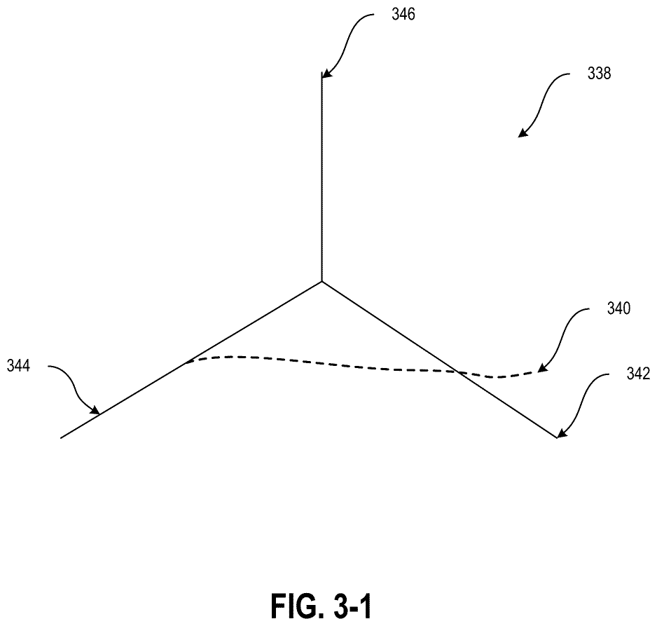

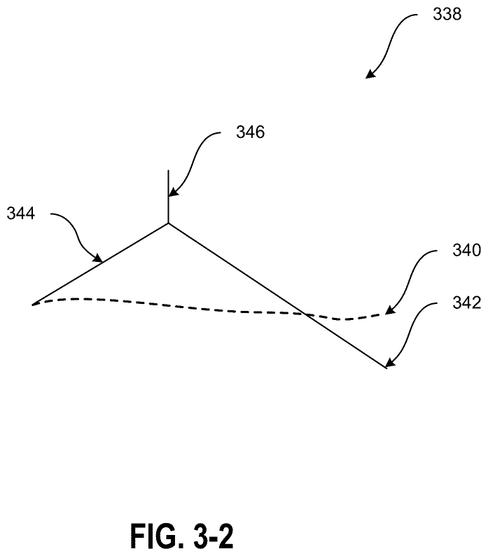

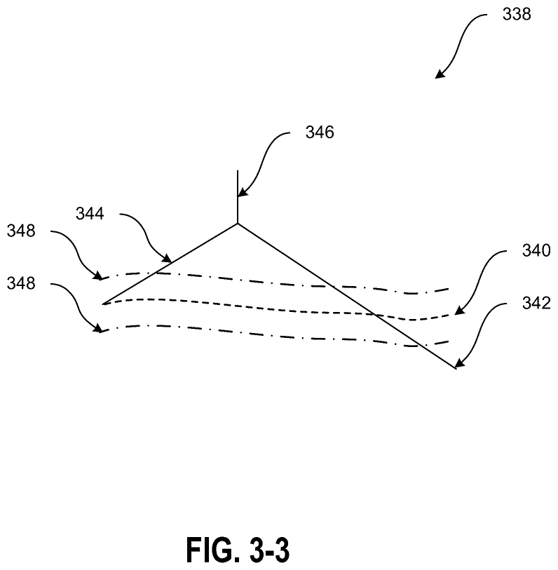

In FIG. 3-2, the seismic volume 338 has been cropped based on the wellbore trajectory 340, As may be seen, the x-axis 342, the y-axis 344, and the z-axis 346 have each been cropped. However, it should be understood that one or more of the axes may not be cropped, based on the wellbore trajectory 340.

In FIG. 3-3, the seismic volume 338 has been masked within a masking range, resulting in masking boundaries 348. The boundaries may be offset from the wellbore trajectory 340 by the masking range in a radius and/or in the direction of the x-axis 342, the y-axis 344, and the z-axis 346. The masking engine may mask any cubes in the seismic volume 338 that do not intersect the boundaries 348.

As discussed herein, the resampler may resample the seismic data. The resampler may resample the seismic data at any time, including at FIG. 3-1, FIG. 3-2, or at FIG. 3-3.

FIG. 4-1 through FIG. 4-4 are representations of seismic surface generation in a cropped, masked, and resampled seismic volume 438, according to at least one embodiment of the present disclosure. In some embodiments, the resampled seismic volume 438 may be the seismic volume 338 processed in FIG. 3-1 through FIG. 3-3. In some embodiments, the resampled seismic volume 438 may be a different seismic volume.

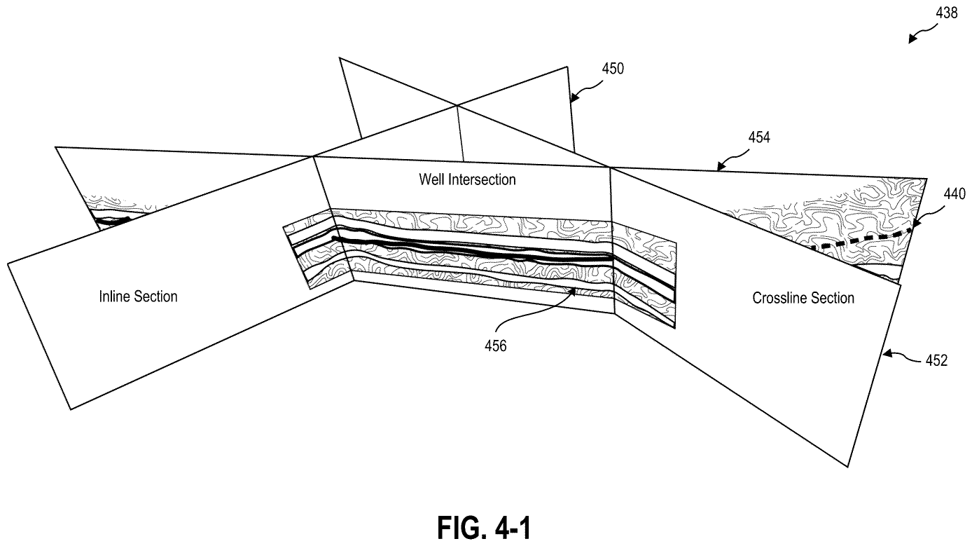

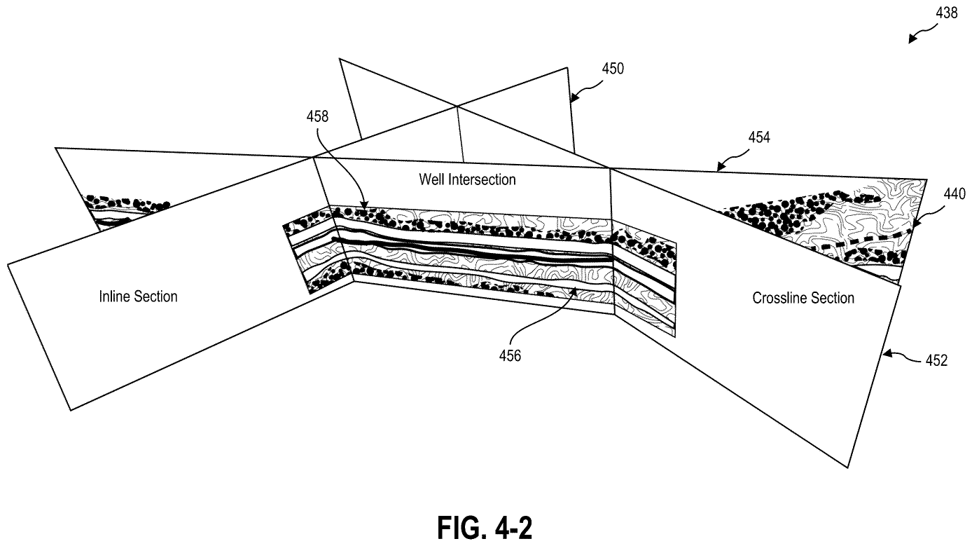

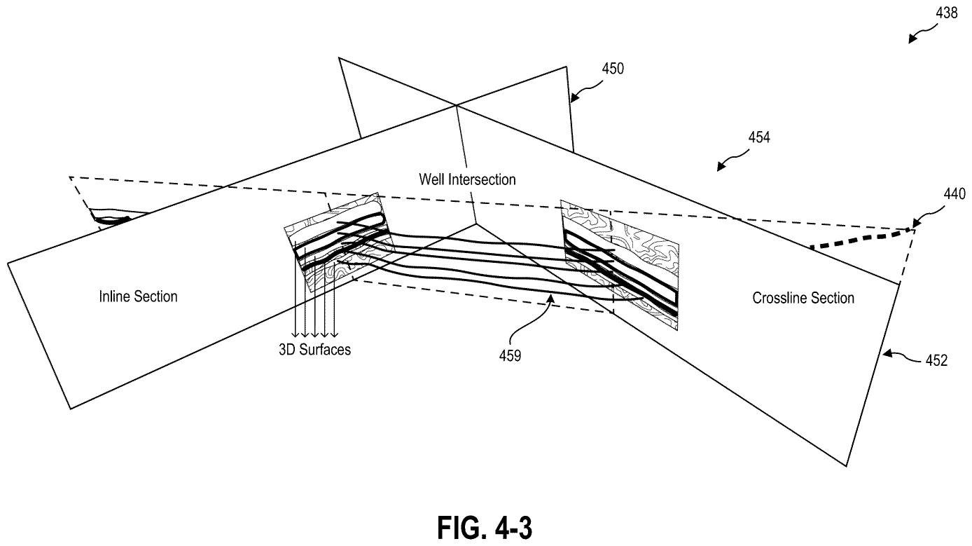

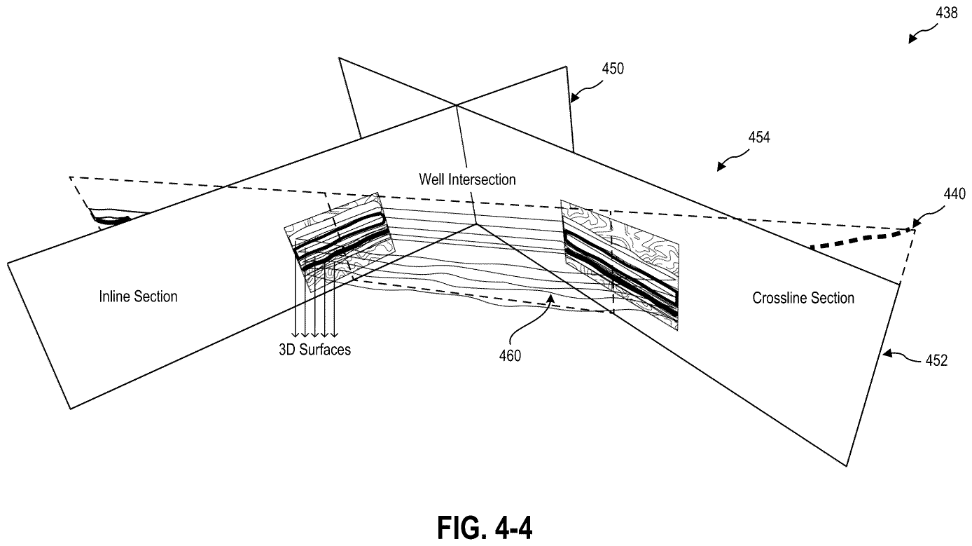

The resampled seismic volume 438 includes an inline section 450, a crossline section 452, and a well intersection 454 along a path of the wellbore trajectory 440. The resampled seismic volume 438 includes seismic data 456. In FIG. 4-2, a patch extractor has identified areas of low SNR 458. The patch extractor may remove the areas of low SNR 458, as may be seen in FIG. 4-3. The remaining patches 459 may be used by the neural network to generate the seismic surfaces 460, as illustrated in FIG. 4-4. An artifact removal engine may identify any artifacts in the seismic surfaces 460, remove the artifacts, and interpolate the holes generated by the artifact removal. This may result in seismic surfaces along the wellbore trajectory 440 that are signal-consistent and representative of the actual geology of the formation.

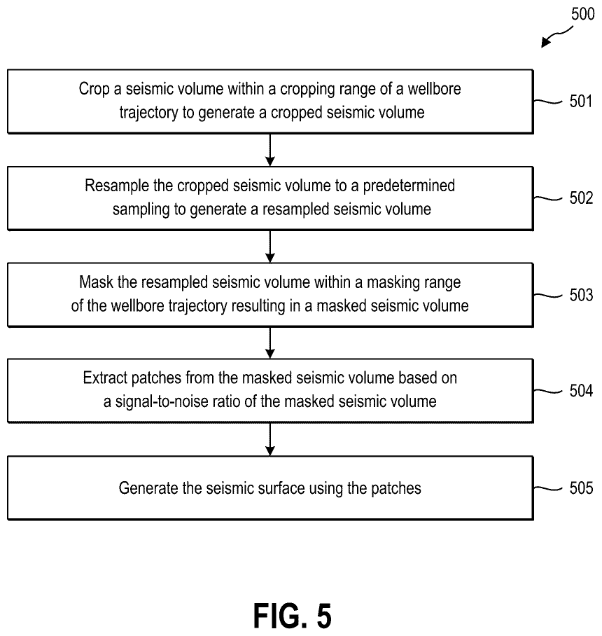

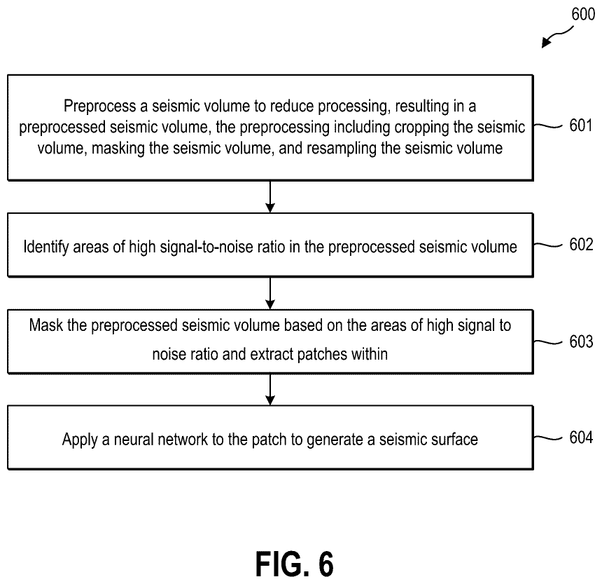

FIGS. 5 and 6, the corresponding text, and the examples provide a number of different methods, systems, devices, and computer-readable media of the seismic surface generation system. In addition to the foregoing, one or more embodiments can also be described in terms of flowcharts comprising acts for accomplishing a particular result, as shown in FIGS. 5 and 6. FIGS. 5 and 6 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts or a method 500 for generating a seismic surface, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

The seismic surface generation system may receive a request to generate a seismic surface. Upon receipt of the request, the seismic surface generation system may receive or request seismic data for a seismic surface. The seismic surface generation system may crop a seismic volume within a cropping range of a wellbore trajectory to generate a cropped seismic volume at 501. The seismic surface generation system may resample the cropped seismic volume to a predetermined sampling frequency to generate a resampled seismic volume at 502. The seismic surface generation system may mask the resampled seismic volume within a masking range of the wellbore trajectory resulting in a masked seismic volume at 503. The seismic surface generation system may extract patches from the masked seismic volume based on a signal-to-noise ratio (SNR) of the masked seismic volume at 504. The seismic surface generation system may generate the seismic surface using the extracted patches.

As mentioned, FIG. 6 illustrates a flowchart of a series of acts or a method 600 for generating a seismic surface, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

A seismic surface generation system may preprocess a seismic volume to reduce processing at 601. Preprocessing may result in a preprocessed seismic volume. The preprocessing includes cropping the seismic volume, masking the seismic volume, and resampling the seismic volume. The seismic surface generation system may identify areas of high signal-to-noise ratio (SNR) in the preprocessed seismic volume at 602. The seismic surface generation system will generate surface patches only in those areas of high SNR at 603. The seismic surface generation system may apply a neural network to the patch to generate a seismic surface at 604.

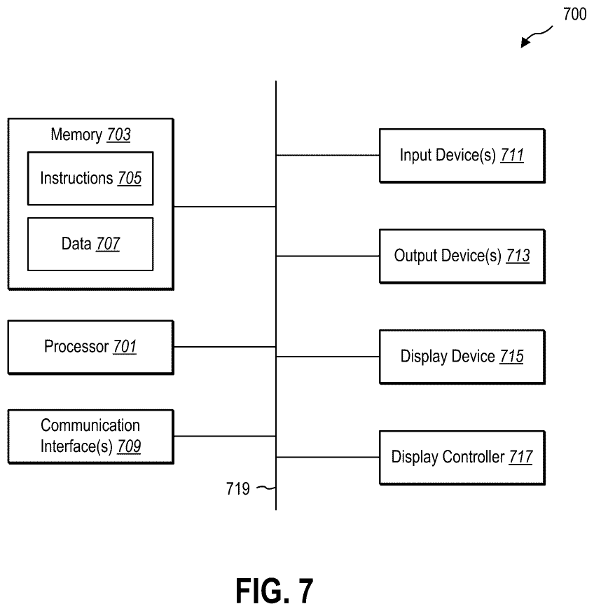

FIG. 7 illustrates certain components that may be included within a computer system 700. One or more computer systems 700 may be used to implement the various devices, components, and systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The embodiments of the seismic surface generation system have been primarily described with reference to wellbore drilling operations; the seismic surface generation system described herein may be used in applications other than the drilling of a wellbore. In other embodiments, seismic surface generation systems according to the present disclosure may be used outside a wellbore or other downhole environment used for the exploration or production of natural resources. For instance, seismic surface generation systems of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for seismic surface generation, the method comprising:
cropping a seismic volume within a cropping range of a wellbore trajectory to generate a cropped seismic volume;
resampling the cropped seismic volume to a predetermined sampling frequency to generate a resampled seismic volume;
masking the resampled seismic volume within a masking range of the wellbore trajectory resulting in a masked seismic volume;
extracting patches from the masked seismic volume based on a signal-to-noise ratio of the masked seismic volume; and
generating a seismic surface using the patches.

2. The method of claim 1, further comprising training a neural network using the patches to generate the seismic surface.

3. The method of claim 2, wherein generating the seismic surface includes completing a signal-consistent surface using the neural network based on the training provided by the patches.

4. The method of claim 3, further comprising removing surface artifacts from the seismic surface.

5. The method of claim 1, wherein extracting the surface patches includes using a Frobenius norm volume technique.

6. The method of claim 1, wherein the cropping range is based on a landing depth and a terminal depth of the wellbore trajectory.

7. The method of claim 1, wherein generating the seismic surface includes generating the seismic surface for a plurality of layers in the seismic volume.

8. A method for seismic surface generation, the method comprising:
preprocessing a seismic volume to reduce processing, resulting in a preprocessed seismic volume, the preprocessing including cropping the seismic volume, masking the seismic volume, and resampling the seismic volume;
identifying areas of high signal-to-noise ratio in the preprocessed seismic volume;
masking the preprocessed seismic volume based on the signal-to-noise ratio; and
using a patch to train a neural network to generate a seismic surface.

9. The method of claim 8, further comprising removing one or more artifacts from the seismic surface.

10. The method of claim 8, wherein identifying the patch includes extracting the patch using an extrema classification methodology.

11. The method of claim 8, wherein identifying the patch includes identifying the patch based on a minimum size of the patch.

12. The method of claim 8, further comprising training the neural network on the patch.

13. The method of claim 12, wherein the patch includes a plurality of patches, and wherein training the neural network includes training the neural network on the plurality of patches.

14. The method of claim 13, wherein the patches form a connected point cloud.

15. A system, comprising:
processor and memory, the memory including instructions that cause the processor to:
crop a seismic volume within a cropping range of a wellbore trajectory to generate a cropped seismic volume;
resample the cropped seismic volume to a predetermined sampling frequency to generate a resampled seismic volume;
mask the resampled seismic volume within a masking range of the wellbore trajectory resulting in a masked seismic volume;
extract patches from the masked seismic volume based on a signal-to-noise ratio of the masked seismic volume; and
generate a seismic surface using the patches.

16. The system of claim 15, wherein the instructions further cause the processor to train a neural network using the patches to generate the seismic surface.

17. The system of claim 16, wherein generating the seismic surface includes interpolating a signal-consistent surface using the neural network based on the patches.

18. The system of claim 17, wherein the instructions further cause the processor to remove surface artifacts from the seismic surface.

19. The system of claim 15, wherein extracting the patches includes extracting the patches using a Frobenius norm volume technique.

20. The system of claim 15, further comprising a seismic source and a seismic sensor, wherein the seismic volume includes seismic data generated by the seismic source and the seismic sensor.
